(19) United States
(12) Patent Application Publication
(10) Pub. No.: US 2024/0354693 A1
(43) Pub. Date: Oct. 24, 2024

(54) SHIPPING MAILER WITH COMMUNICATION LINK FOR ACTIVATION

(71) Applicant: 3M INNOVATIVE PROPERTIES COMPANY, St. Paul, MN (US)

(72) Inventors: Sithya S. Khieu, Eden Prairie, MN (US); Sara Maneiro Rey, Audoen (IE); Alexander C. Guckenberger, Woodbury, MN (US); Mitchell A. Giannini, Stillwater, MN (US); Eric T. Walker, Edina, MN (US); Lisa M. Miller, Spring Valley, WI (US)

(21) Appl. No.: 18/685,646

(22) PCT Filed: Sep. 9, 2022
(86) PCT No.: PCT/IB2022/058520

§ 371 Date: Feb. 22, 2024

Related U.S. Application Data
(60) Provisional application No. 63/247,905, filed on Sep. 24, 2021.

(51) Int. Cl. G06Q 10/0836; G07B 17/00

(52) U.S. Cl. CPC G06Q 10/0836; G07B 17/00508; G07B 2017/0058

(57) ABSTRACT

An electronically activated mailer capable of containing one or more articles to be shipped and having an activation code on the mailer or a receipt for it. The purchaser or user of the mailer scans the activation code, such as a QR code, using a digital camera on a mobile phone and, upon receiving the scan, the mobile phone is linked to a web application. The validity of the activation code is verified, possibly using a verification code on the mailer. Upon verifying the activation code, the mailer is activated to receive via the web application destination and return addresses and pick-up information for the mailer. The pick-up information payment are provided to a carrier for delivery of the mailer. Purchase of the mailer can also possibly be used to access shipping services via the web application.

### BACKGROUND

Consumers find shipping and mailing items from their homes or small businesses confusing and costly because the parcel packaging materials that they select can affect the cost. In general, the bulkier the materials the more the consumers perceive that their items will be protected. However, using bulky materials will mean more shipping or mailing cost. Accordingly, a need exists to simplify shipping and mailing by providing the most suitable materials with the conveniences of shipping.

### SUMMARY

A method of providing shipping services includes linking a user computer to an application upon receiving the user computer scan of an activation code for a mailer. The method verifies whether the activation code is valid for the mailer. If the activation code is valid, the method activates the mailer to receive from the user, via the application, shipping information and pick-up information for the mailer and to provide the pick-up information to a carrier to deliver the mailer.

An electronically activated mailer includes a mailer capable of containing one or more articles to be shipped and an activation code for the mailer. Upon receiving a user computer scan of the activation code the user computer is linked to an application. Upon verifying validity of the activation code the mailer is activated to receive, via the application, shipping information and pick-up information for the mailer.

### BRIEF DESCRIPTION OF THE DRAWINGS

FIG. 1 is a diagram of an exemplary computer system for processing a shipping mailer having a communication link for activation.

FIG. 2 is a flow chart of a process to activate a shipping mailer.

FIGS. 3A-3E are diagrams of user interfaces to enter information for a shipping mailer.

### DETAILED DESCRIPTION

Embodiments includes a parcel packaging material having a communication link to a web application allowing users to obtain shipping and mailing services without having to go to a carriers' location. Carriers can include, for example, the U.S. Postal Service and delivery companies. In addition, the transportation information of the item via the selected shipping or mailing services can be used to improve the parcel packaging material. Embodiments addresses a need to balance the use of material and cost saving. They also create an opportunity to introduce services as part of physical packaging material with associated revenue for the services. The information can be used to help improve the shipping and transportation services and also improve the physical parcel packaging material.

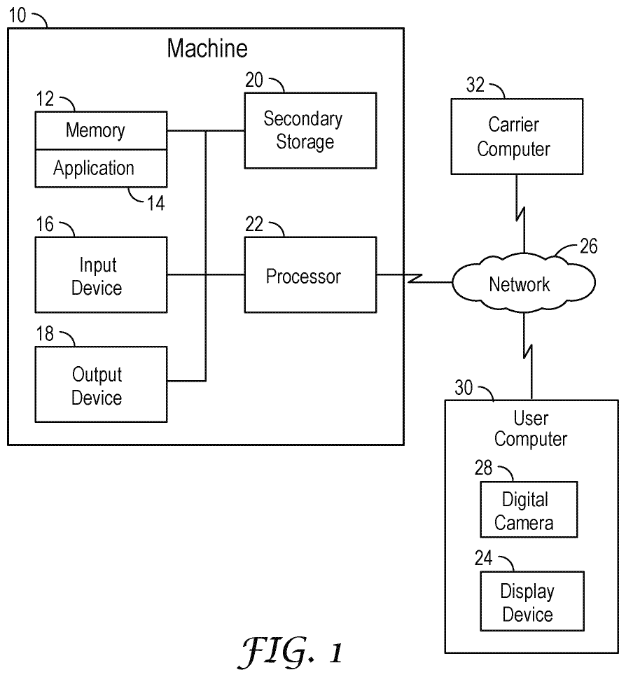

FIG. 1 is a diagram of an exemplary machine or computer 10 for processing a shipping mailer having a communication link for activation. Machine 10 can include, for example, the following components: a memory 12 storing one or more applications 14; a secondary storage 20 for providing non-volatile storage of information; an input device 16 for entering information or commands into machine 10; a processor 22 for executing applications stored in memory 12 or secondary storage 20, or as received from another source; and an output device 18 for outputting information, such as a printer for providing hard copies of information in printed form or speakers for providing information in audio form. Machine 10 can include a connection to a network 26 such as the Internet, an intranet, or other type of network. Machine 10 can include a connection via network 26 to a carrier computer 32. The system can also include a connection via network 26 to a user computer 30 such as a mobile phone or tablet computer. Machine 10 can be implemented as, for example, a web server to host a web application. Carrier computer 32 can have, for example, the same or similar components as machine 10. User computer 30 can have, for example, the same or similar components as machine 10 and also have a display device 24 for electronically displaying information in visual or audiovisual form and a digital camera 28 or other image capture device for capturing digital images.

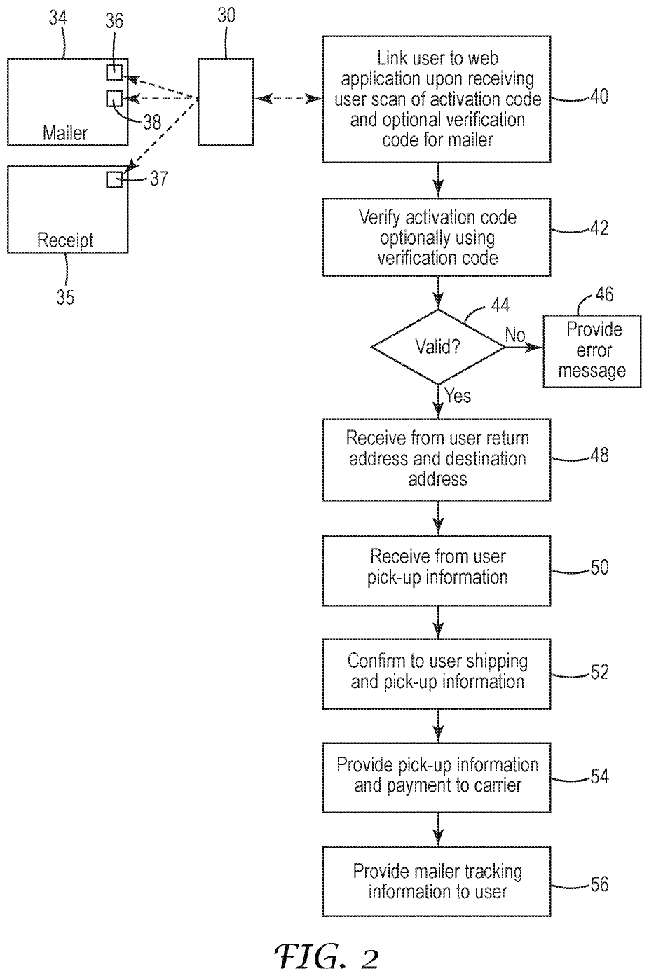

FIG. 2 is a flow chart of a process to activate a shipping mailer. This process can be implemented in software or firmware, for example application 14, for execution by a processor such as processor 22.

This process links a user to a web application upon receiving the user's scan of an activation code and optional verification code for a mailer (step 40). Activation and verification codes can be implemented with, for example, a quick response (QR) code, a bar code, a series of numbers or letters or both, or an intrinsic pattern marking that can be decoded by the web application. The link can occur via user computer 30 (e.g., mobile phone) through network 26 such as the Internet. Using digital camera 28 in user computer 30, the user scans an activation code 36 and optional verification code 38 on a mailer 34. Codes 36 and 38 can be scanned together, at the same time, or scanned separately. Alternatively, the user can scan an activation code 37 on a receipt 35 for mailer 34. Verification code 38 can alternatively be manually entered through a user interface as described below. Mailer 34 can include verification code 38 as a scratch-off where the user removes (e.g., scratches off) a thin covering over verification code 38 in order to reveal the code for the user to manually enter in a user interface or scan using a digital camera. As another alternative, activation code 36 can be included on mailer 34 as a scratch-off with verification code 38 embedded within activation code 36. In that case, the user would remove the scratch-off covering to reveal activation code 36 with embedded verification code 38 to be scanned using a digital camera in user computer 30. Aside from a scratch-off, an adhesive label could be used to cover activation code 36 and verification code 38 on mailer 34 prior to purchase of the mailer. Activation code 36 for mailer 34 can optionally expire after a certain time period. Activation code 36 can also optionally be used to later return to and edit the shipping information and other add-on services. An intrinsic pattern could be used such that the activation code inconspicuous for additional anti-counterfeiting security.

The mailer can be, for example, an envelope, box, or other type of shipping article with the codes 36 and 38 printed on or otherwise affixed to mailer 34. The user would typically purchase mailer 34 at a retail location, and the cost of the mailer would cover the delivery cost along with the associated shipping services. For example, mailer 34 can be a flat rate envelope or box where any articles that fit within the envelope or box are delivered at the flat rate. Other possible shipping services include the following: providing for the mailer to be re-usable; the ability to intercept the mailer when in route for delivery; and return of the mailer to the return address.

The process verifies activation code 36 optionally using verification code 38 (step 42). If activation code 36 is not valid (step 44), the process can display an error message to the user on user computer 30 (step 46) and optionally provide contact information for technical support in order to resolve the error. The process can verify activation code 36 by accessing a database (e.g., secondary storage 20) of valid verification codes for mailers and determining if verification code 38 associated with activation code 36 is within the database.

Prior to sending mailers to retail or other locations for sale, the process can generate an activation code for each mailer, assign a unique verification code to each activation code, and record the activation codes and assigned verification codes in the database. It is also possible that the code is activated having a pre-paid record with one or more carriers and that the code can then be scanned and recognizable by the carriers as a legitimate “postage stamp” or delivery fee. In this case, the pick-up information for the mailer can be optional in that a user can deposit the mailer in a mailbox or other delivery receptable, and the carrier can scan the code on the mailer to verify and confirm the code represents the required delivery fee. Once mailer 34 is activated, the process can also store other information in the database associated with the activated mailer, such as the following: the user's contact information; the shipping information possibly for use in generating a shipping label; the pick-up information; the carrier's tracking number for the mailer; and any related delivery information.

If activation code 36 is valid (step 44), the process activates mailer 34. In particular, the process receives from the user, via user computer 30, a return address and a shipping address for mailer 34 (step 48). The process also receives from the user, via user computer 30, pick-up information for mailer 34 (step 50). The pick-up location can be, for example, at the retailer where the user purchased mailer 34 or at another location selected by the user. In this way, the user need not take the mailer to the carrier's location for delivery. Also, the carrier can possibly bring a shipping label when picking up mailer 34 so that the user and retailer need not generate and apply a shipping label to mailer 34.

The process confirms to the user, via user computer 30, the shipping information and the pick-up information (step 52). The process provides the pick-up information and payment to a carrier (step 54). The pick-up information and payment to the carrier can be provided through the carrier's application programming interface (API) or web site by accessing carrier computer 32 via network 26.

The process also provides tracking information to the user, via user computer 30, in order to track the progress of shipping mailer 34 (step 56). The tracking information can be provided through the carrier's web site, and the process can provide the user with a network link to the carrier's web site so that the user can track delivery of mailer 34. Aside from the verification code, mailer 34 can include additional security features.

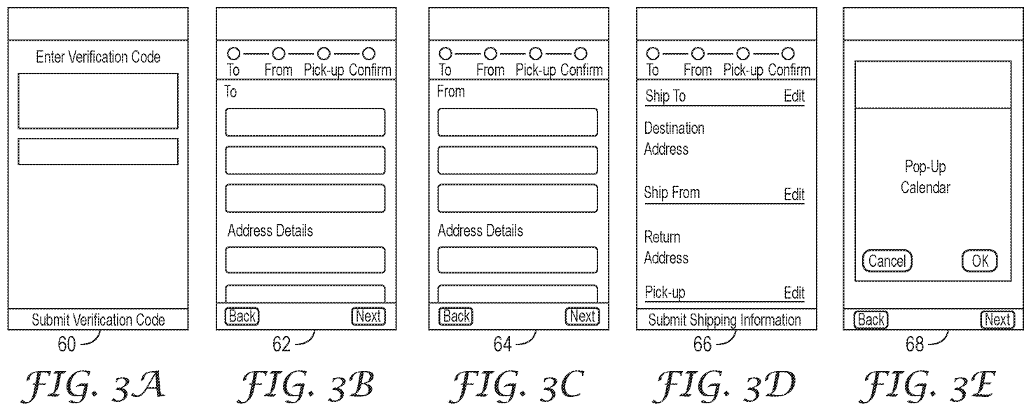

FIGS. 3A-3E are diagrams of user interfaces or display screens to enter information for a shipping mailer. These user interfaces can be displayed on display device 24, such as an electronic touch screen display, on user computer 30 such as the user's mobile phone.

FIG. 3A shows a user interface 60 for the user to enter a verification code. User interface 60 includes a section for the user to enter the verification code, a section for possible instructions on how to locate the verification code, and section to submit the verification code.

FIG. 3B shows a user interface 62 for the user to enter destination address information. User interface 62 includes a section to enter a name or identification of a recipient for the mailer and a section to enter destination address details. FIG. 3C shows a user interface 64 for the user to enter return address information. User interface 64 includes a section to enter a name or identification of a sender of the mailer and a section to enter return address details. FIG. 3D shows a user interface 66 to confirm to the user the shipping information. User interface 66 includes a section to display the destination address (“Ship to”), a section to display the return address (“Ship From”), and a section to submit the shipping information. User interface 66 also includes Edit buttons for the user to select in order to edit the displayed shipping information and a Pick-up button for the user to select in order to enter pick-up information such as a pick-up location and date. FIG. 3E shows a user interface 68 for the user to enter and confirm pick-up information for the mailer. User interface 68 can include, for example, a pop-up calendar for the user to select a date for the carrier to pick up the mailer for delivery. The user can possibly enter a pick-up date in other ways. User interface 68 can also include a section to enter the pick-up location, for example the retailer where the user purchased the mailer.

User interfaces 62, 64, and 66 can optionally include a status bar to show the user's status in entering information. As shown, the status bar can include To, From, Pick-up, and Confirm sections, which can illustrate the user's progress. For example, as the user navigates from one user interface to the next, the status sections can progressively be changed (e.g., displaying a check mark in the corresponding circle) to display the user's progress in entering information.

1. A method of providing shipping services, comprising steps of executed by a processor:
linking a user computer to an application upon receiving the user computer scan of an activation code for a mailer;
verifying whether the activation code is valid for the mailer; and
if the activation code is valid, activating the mailer, comprising:
receiving from the user, via the application, shipping information for the mailer;
receiving from the user, via the application, pick-up information for the mailer; and
providing the pick-up information to a carrier to deliver the mailer.

2. The method of claim 1, wherein the linking step comprises receiving the scan of the activation code on the mailer.

3. The method of claim 1, wherein the linking step comprises receiving the scan of the activation code on a receipt for the mailer.

4. The method of claim 1, wherein the linking step comprises receiving the scan of at least one of a quick response (QR) code, a bar code, a series of numbers or letters or both, or an intrinsic pattern marking that can be decoded by the application.

5. The method of claim 1, wherein the receiving shipping information step comprises receiving from the user a return address and a destination address for the mailer.

6. The method of claim 1, further comprising receiving a verification code for the mailer.

7. The method of claim 6, wherein the receiving the verification code step comprises receiving the user computer scan of a verification code on the mailer.

8. The method of claim 6, wherein the receiving the verification code step comprises presenting on the user computer a user interface for the user to enter the verification code.

9. The method of claim 6, wherein the verifying step comprises using the verification code to determine if the activation code is valid.

10. The method of claim 1, further comprising confirming to the user, via the application, the shipping information and the pick-up information.

11. The method of claim 1, further comprising providing tracking information to the user in order to track delivery of the mailer by the carrier.

12. The method of claim 1, further comprising providing payment to the carrier for delivery of the mailer.

13. The method of claim 5, wherein receiving the shipping information comprises
presenting on the user computer a first user interface for the user to enter the destination address and a second user interface for the user to enter the return address, and
presenting on the user computer a third user interface to confirm the destination address and the return address.

14. (canceled)

15. The method of claim 1, wherein:
the receiving the pick-up information step comprises presenting on the user computer a user interface for the user to enter the pick-up information, and
presenting comprises presenting a calendar on the user interface for the user to select a date for the pick-up information.

16. (canceled)

17. An electronically activated mailer, comprising:
a mailer capable of containing one or more articles to be shipped; and
an activation code for the mailer, wherein upon receiving a user computer scan of the activation code the user computer is linked to an application, and upon verifying a validity of the activation code the mailer is activated to receive via the application shipping information and pick-up information for the mailer.

18. (canceled)

19. The mailer of claim 17, wherein the activation code is on a receipt for the mailer.

20. The mailer of claim 17, wherein the validity of the activation code is verified based upon a verification code on the mailer.

21. The mailer of claim 17, wherein the activation code comprises a quick response (QR) code, a bar code, a series of numbers or letters or both, or an intrinsic pattern marking that can be decoded by the application.

22. The mailer of claim 20, wherein the verification code comprises a quick response (QR) code, a bar code, a series of numbers or letters or both, or an intrinsic pattern marking that can be decoded by the application.

23. An electronically activated mailer, comprising:
a mailer capable of containing one or more articles to be shipped; and
an activation code for the mailer, wherein upon receiving the mailer for delivery a carrier can scan the activation code to confirm that the activation code represents a required pre-paid fee for delivery of the mailer by the carrier.
